(19) United States
(12) Patent Application Publication
(10) Pub. No.: US 2014/0098643 A1
(43) Pub. Date: Apr. 10, 2014

(54) VERMIN REPELLING DEVICE AND METHOD

(71) Applicant: Industrial Engineering & Automation Solutions Limited, Mount Pearl (CA)

(72) Inventors: Michael S. Power, St. John's (CA); Arthur Garland, Mount Pearl (CA)

(73) Assignee: Industrial Engineering & Automation Solutions Limited, Mount Pearl (CA)

(21) Appl. No.: 13/974,600

(22) Filed: Aug. 23, 2013

(30) Foreign Application Priority Data
Aug. 24, 2012 (CA) 2 787 857

(51) Int. Cl. A01M 29/18

(52) U.S. Cl. CPC A01M 29/18
USPC 367/139

(57) ABSTRACT

A device and a method are provided for repelling animals, namely vermin. The device is electrically powered and includes a sound emitter; and a circuit operatively connected to the sound emitter to cause the sound emitter to produce an ultrasonic sound to discourage the vermin from at least one of entering and remaining within a vicinity of the device. The ultrasonic sound has a frequency in the range of approximately 21.5 kHz to 30 kHz. The sound can be cycled on and off to reduce the chance of vermin becoming accustomed to the sound.

### BACKGROUND

1. Field of the Invention

The present disclosure relates generally to devices and methods for repelling animals, and more particularly to an electrically powered device that emits a sound to repel animals.

2. Description of the Related Art

Animals, including rodents and other vermin, pose many problems in places where food and/or other edible material is produced, processed and stored. For example, feed for poultry, cattle, pigs, and other livestock can be contaminated by way of animal droppings getting mixed with the feed and then ingested by the livestock. Another problem caused by vermin is the actual volume of food that they consume.

The costs associated with losses due to consumed and contaminated foods vary by geographical area and have been studied by various government agencies worldwide. It is estimated these losses amount from 0.5 to 12% of crop yields on a yearly basis, depending on the geographical area. In addition to food consumption and contamination, vermin and other animals cause damage to property including personal property, building materials and electrical wiring.

The monetary impact of these losses is estimated in the billions of dollars per year. Over the years, vast improvements in chemical intervention, such as hormone blockers and various blood anti-coagulators, have made their way into the market place. These chemicals can sometimes end up in the animals or livestock when the animal ingests all or parts of a carcass of a dead vermin.

Mechanical spring traps and other numerous other methods have been used for millennia with marginal results, as some vermin learn to avoid them.

For the foregoing reasons, it can be appreciated that a need exists for new ways of repelling vermin and other unwanted animals.

### SUMMARY OF THE INVENTION

In one aspect, the present disclosure is directed to a method for repelling vermin, the method comprising using a sound emitter to emit an ultrasonic sound to discourage the vermin from at least one of entering and remaining within a vicinity of the sound emitter, the sound having a frequency in the range of approximately 21.5 kHz to 30 kHz.

In another aspect, the present disclosure is directed to a device for repelling vermin, the device comprising: a sound emitter; and a circuit operatively connected to the sound emitter to cause the sound emitter to produce an ultrasonic sound to discourage the vermin from at least one of entering and remaining within a vicinity of the device, the ultrasonic sound having a frequency in the range of approximately 21.5 kHz to 30 kHz.

The present disclosure will be better understood having regard to the drawings.

### BRIEF DESCRIPTION OF THE DRAWINGS

FIG. 1 is a block diagram of at least one embodiment of the present vermin repelling device.

FIG. 2 is a circuit schematic diagram of at least one embodiment of the present vermin repelling device.

FIG. 3 is an example flow chart indicating various modes and states of at least one embodiment of the present vermin repelling device.

FIG. 4A is a perspective view of at least one embodiment of the present vermin repelling device with the assembly housing in an open position.

FIG. 4B is a front perspective view of the embodiment of the present vermin repelling device shown in FIG. 4A.

FIG. 4C rear perspective view of the embodiment of the present vermin repelling device shown in FIG. 4A.

### DETAILED DESCRIPTION OF THE PREFERRED EMBODIMENTS

In one aspect, the present disclosure relates to a device and method for emitting an unpleasant irritating high sound pressure level ultrasonic frequency sound to repel vermin and other animals from a vicinity of the device.

In one aspect, the present disclosure provides a method for repelling vermin using a sound emitter for emitting an ultrasonic sound to discourage vermin and other animals from at least one of entering and remaining within a vicinity of the sound emitter. In at least one embodiment, the emitted sound will have a frequency of 20 kHz or more and thus will generally not be audible to humans. In one or more embodiments, the sound can have a frequency in the range of approximately 21.5 kHz to 30 kHz. In at least one embodiment, the sound can have a frequency in the range of approximately 23 kHz to 25 kHz.

In another aspect, the present disclosure provides a method for repelling vermin using a sound emitter for emitting an ultrasonic sound, wherein the sound is cycled on and off to reduce the chance of vermin becoming accustomed to the sound. In at least one embodiment, the sound can be cycled on and off randomly or pseudo-randomly.

In at least another aspect, the present disclosure provides a method for repelling vermin using a sound emitter for emitting an ultrasonic sound, wherein the sound has a variable frequency, meaning that the frequency can change over time. In at least one embodiment, the sound can comprise one or both of a frequency upsweep (frequency increases) and a frequency downsweep (frequency decreases).

In another aspect, the present disclosure provides a method for repelling vermin using a sound emitter for emitting an ultrasonic sound comprising a composite waveform. In at least one embodiment, the device can comprise two or more sound emitters and the sound produced by each sound emitter can result in a composite waveform.

In another aspect, the present disclosure provides a method for repelling vermin using a sound emitter for emitting an ultrasonic sound having a sound pressure level (e.g. amplitude) above approximately 90 decibels (dB). In at least one embodiment, the emitted sound can have a sound pressure level in the range of approximately 100 dB to 110 dB.

In another aspect, the present disclosure provides a method for repelling vermin using a sound emitter for emitting an ultrasonic sound, wherein the sound emitter is in the form of a piezoelectric transducer. In at least one embodiment, the piezoelectric transducer comprises a ceramic portion, a metal portion bonded to the ceramic portion, the metal portion comprising a protuberance extending on a side of the metal portion that is opposite to the ceramic portion. In at least one embodiment, the protuberance can increase the power sound pressure level of the transducer.

In another aspect, the present disclosure provides a repelling device for implementing the present methods. In at least one embodiment, the device comprises a sound emitter, and a circuit operatively connected to the sound emitter to cause the sound emitter to produce an ultrasonic sound to discourage the vermin from entering and remaining within a vicinity of the device.

Vermin and other animals can have a heightened sensitivity to high frequency energy, and in particular to high frequency energy in the low ultra-sonic region. The high frequency energy will generally not bring about imminent death to the vermin or other animals. However, if suitably applied, the energy can be used to repel and keep away vermin and other animals from a vicinity of the high frequency device. This can be useful in areas in which food or other edible material is located, for example in homes, on farms, processing plants, storage locations, etc.

In one aspect, the present methods and devices are based on generating an ultrasound frequency composite waveform signal that can be localized and intermittently generated so as not to allow the vermin or other animals to become accustomed to the sound. We have discovered that this form of a sound burst causes extreme irritation to vermin and other animals.

In one aspect, the effectiveness of the present device and method relies on the suitable placement of one or more repelling devices in an area or areas that are to be kept free of vermin. The number of repelling devices and their locations can depend on the specific application in which they are employed. Each device will generally have an effective range. Thus, the number of devices that are required can vary with the size of the area that is to be protected. The number of devices can also vary with the specific physical layout of the area. For example, if the area has one or more objects that obstruct the travel of the sound emitted by the devices, then additional devices may be needed to be used to ensure adequate and effective coverage.

The various features and components of the present repelling device and method are now described with reference to the Figures.

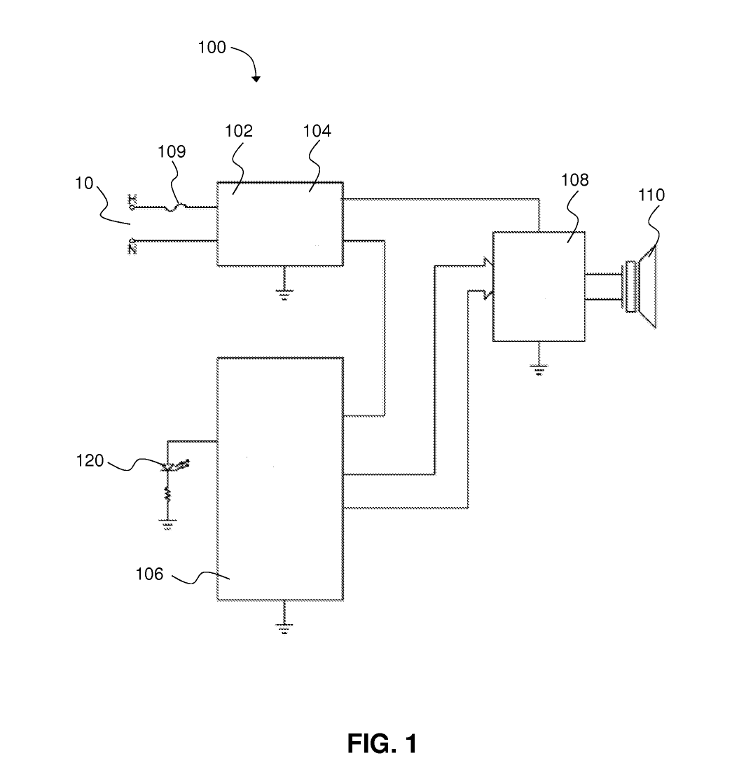

FIG. 1 shows a block diagram of at least one embodiment of the present vermin repelling device. Device 100 generally comprises a sound emitter 110 and circuitry operatively connected to sound emitter 110 to cause the emitter to produce an ultrasonic sound to discourage vermin from at least one of entering and remaining in a vicinity of the device. The circuitry can include an interface driver circuit 108 for driving sound emitter 110.

Sound emitter 110 can be any suitable sound emitting device. In at least one embodiment, sound emitter 110 can be in the form of a piezoelectric transducer. In at least one embodiment, sound emitter 110 can be in the form of a piezoelectric transducer that comprises a ceramic portion, a metal portion bonded to the ceramic portion, the metal portion comprising a protuberance extending on a side of the metal portion that is opposite to the ceramic portion, the protuberance for increasing the sound pressure level of the sound produced by the transducer. One type of piezoelectric transducer that we have found to be suitable is a “piezo transducer disc shape”, having part number SMUN15MT19F22 and manufactured by Steiner and Martin Inc. This transducer is approximately 19 mm in diameter and comprises a piezoelectric portion bonded to a metal portion. The transducer also has a protuberance at the metal layer and extending on a side of the metal portion that is opposite to the ceramic portion. The protuberance can increase the sound pressure level of the sound produced by the transducer. However, this specific transducer is only an example is not intended to be limiting.

In one or more embodiments, the device can comprise two or more sound emitters. The device may comprise one or more additional components to enable the working of the additional sound emitters.

In addition, device 100 can comprise a processor 106 for various functions, including producing a signal that is transformed and emitted by sound emitter 110. Furthermore, the device can comprise a housing for receiving one or more of its components (not shown in FIG. 1). Device 100 may also comprise one or both of a power transformer 102 and a power regulator 104. Transformer 102 and regulator 104 can be used to modify and regulate the input power to the device. The device may be coupled to any suitable source of power, including grid power or one or more batteries. In at least one embodiment, the device can be battery operated. One or both of transformer 102 and regulator 104 may be necessary where, for example, the device is electrically coupled to a grid power source, such as a conventional electrical socket. One or more fuses 109 may be located between power transformer 102 and/or power regulator 104. In at least one embodiment, the one or more fuses 109 can provide for protection against excessive current draw by the device. In addition, transformer 102 can also comprise one or more fuses, for example, a thermal fuse to protect against overheating. Device 100 may also comprise one or more lights 120 for providing visual indications. Visual indications can include but are not limited to the operational state of the device and whether or not the device has suffered a failure. Other indications are possible. The visual indications can be in the form of different colours and/or the flashing or flashing pattern of one or more lights 120. In at least one embodiment, one or more lights 120 will be in the form of one or more light emitting diodes (LEDs).

Various operational modes of the device are now described.

As discussed above, in one aspect, the present disclosure provides a device and method for emitting an ultrasonic sound to repel vermin and other animals from a vicinity of the device. The sound can be irritating and thus very unpleasant to the vermin, thereby causing them to move away from the source of the sound.

We have discovered that a sound having a frequency in the ultrasonic range of approximately 21.5 kHz to 30 kHz and having a sound pressure level at or above approximately 90 dB is very irritating to vermin. In at least one embodiment, the sound can have a frequency in the range of approximately 23 kHz to 25 kHz. These frequencies are generally not audible to humans but can be heard by many types of animals, including vermin. In addition, we have found that an emitted sound having an even greater sound pressure level is even more irritating to vermin. For example, in at least one embodiment of the present device and method, the emitted sound can have a sound pressure level within the range of approximately 100 dB to 110 dB. In at least another embodiment, the sound can have a sound pressure level of approximately 105 dB. These values and ranges are only examples and are thus not intended to be limiting.

The operational range of the device in terms of distance can vary depending on one or more factors, including the sound pressure level of the emitted sound. In at least one embodiment, the device has an operational range of approximately 0 to 10 feet. However, it is possible that other embodiments can have different operational ranges.

In addition, in at least one embodiment, the emitted sound can be continuously cycled on and off. This cycling can be done to reduce the chance that vermin or other animals become partially or fully accustomed to the sound. It is possible that if an animal becomes accustomed to the sound, the animal can be less likely to be repelled away from the vicinity of the device. For example, the device can emit the sound for a period of X seconds, and then go silent for a period of Y seconds. The variables X and Y can have any value. In at least one embodiment, the on/off cycle can comprise an on period of approximately 1 to 5 seconds and an off period of approximately 1 to 5 seconds. In another embodiment, the on/off cycle can comprise an on period of approximately 2 seconds and an off period of approximately 2 seconds. Again, these values are examples only and are not meant to be limiting.

In addition, in at least one embodiment, the duration of one or both of the on and off periods can have random or pseudo random values. The random on and/or off cycling of the emitted sound can further reduce the chance that vermin or other animals become accustomed to the sound. For example, the emitted sound could be emitted for a period of X seconds, followed by a silent period of Y seconds, followed by an on period of W seconds, followed by a silent period of Z seconds, where one or more of the values of X, Y, W and Z are random.

Furthermore, in at least one embodiment, the sound pressure level of the emitted sound can be varied. For example, in at least one embodiment, the sound pressure level can be maintained at a certain value for a specific time, and then changed to and maintained at a different sound pressure level for a specific time, and so on. In at least another embodiment, the sound pressure level can be varied continuously over a time period. For example, the pressure level can be increased for a specific time, and then decreased for a specific time, and so on. In one or more embodiments, a combination of the foregoing sound pressure level varying techniques can be employed.

In another embodiment, the emitted sound can comprise a composite waveform.

As previously mentioned, in at least one embodiment, the device can comprise two or more sound emitters. In one or more embodiments, different sound emitters can generate different sounds, for example having different frequencies and/or sound pressure levels. In at least one embodiment, the emitted sound of the two or more sound emitters of the device can produce a resulting composite waveform.

Furthermore, in at least one embodiment, the sound can have a variable frequency, meaning that the frequency of the sound can change over time. In at least one embodiment, the device can emit a swept frequency output sound. For example, the frequency of the sound can increase over a period of time (e.g. an upsweep), and then decrease over a period of time (e.g. a downsweep). This up and down cycle can be repeated continuously. In another embodiment, the frequency could vary randomly. In a further embodiment, the frequency can vary in only one of an upsweep or a downsweep. After a specific amount of time, the upsweep or downsweep can simply be restarted. Other options for varying the frequency of the emitted sound over time are possible.

Some or all of the foregoing acoustic operational modes and behaviour of the present device can be controlled by any suitable component of the device, for example a processor of the device. In addition, some or all of the foregoing acoustic operational modes and behaviour can be preprogrammed to the device.

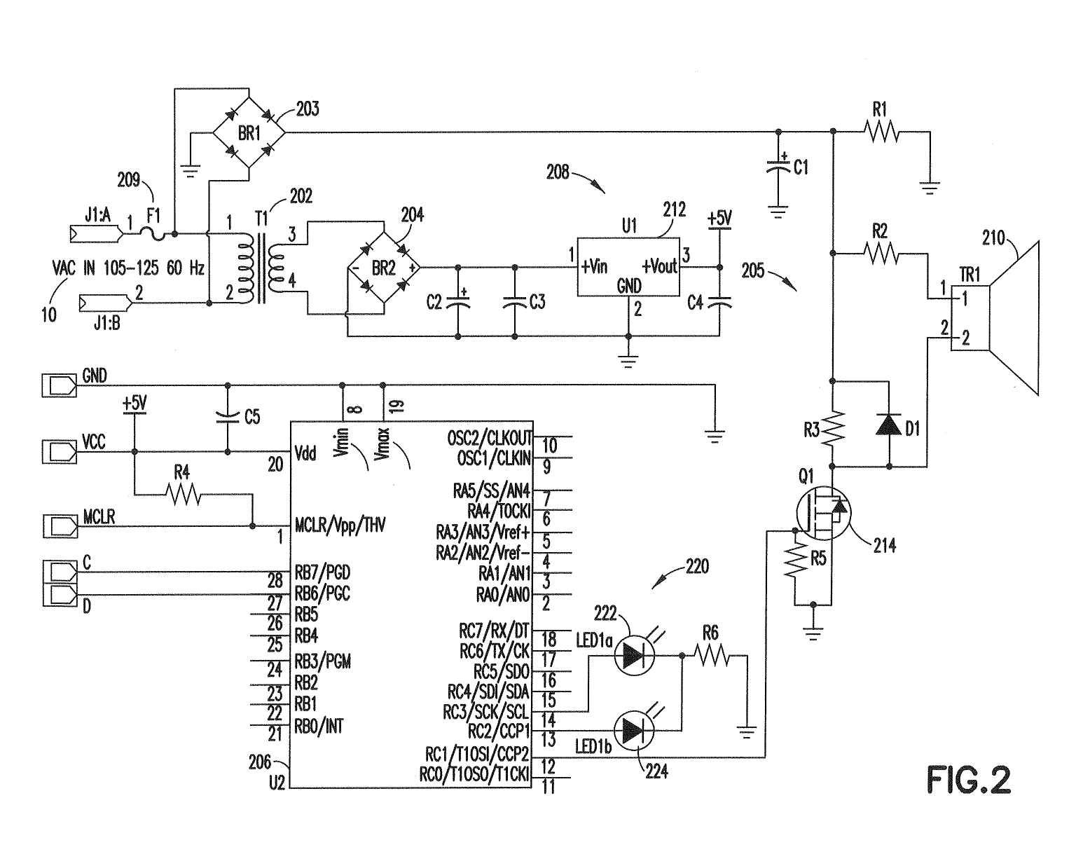

FIG. 2 shows a circuit schematic diagram of at least one embodiment of the present vermin repelling device. Again, the device can be electrically coupled to any suitable power source 10. In this embodiment, power for device 200 is sourced from a typical household wall power outlet through to transistor T1 202. The power can then be rectified into direct current (DC) via diode bridge BR1 203 and diode bridge BR2 204, respectively. Bridge BR1 203 supplies power for a sound emitter circuit 205 and bridge BR2 204 for the power requirements of the balance of circuits 208. A fuse 209 can be positioned in series with the hot side of the AC power transformer T1 202 input. In addition, the device can be programmed as required.

Voltage regulator U1 212 supplies processor U2 206 and supporting circuits with +5 volts direct current. Transistor Q1 214 functions as a switch driven by processor U2 206 and is further connected through to sound emitter 210. The device can contain other components, including passive components such as resistors and capacitors. These other components can be used for one or more purposes, including as signal decoupling for capacitors and biasing and/or current limiting for the resistors.

As previously discussed, the device can comprise one or more lights for providing visual indications. The visual indications can include but are not limited to the operational state of the device and whether or not the device has suffered a failure. Other indications are possible. The visual indications can be in the form of different colours and/or the flashing or flashing pattern of one or more lights. In the embodiment shown in FIG. 2, the device comprises two LEDs, 222 and 224, respectively. LEDs 222 and 224 can serve as a power indicator lamp. A power lamp indicator can indicate that the device is functioning. The LEDs may also signal diagnostic feedback of the device. Furthermore, LEDs 222 and 224 can be integrated into one LED assembly.

LEDs 222 and 224 can form a tri-color assembly, meaning that they can cooperate to produce at least three colours. In the present embodiment, LEDs 222 and 224 can cooperate to produce red, green and orange light. Other colours and colour combinations are possible. The one or more colours can be emitted to provide a visual indication of a state, event or other indication.

Furthermore, the one or more lights or LEDs can turn on or off to provide a visual indication. For example, in the present embodiment, LEDs 222 and 224 can be used in the following manner to provide visual indications. A fast flashing red 100 millisecond (ms) on and 250 ms off can indicate that there are internal problems with the circuit(s) or other device components. When red light is being emitted, it is possible that no other colours will be emitted. A slow flashing green pulsing display can indicate the module is functioning correctly. For example, green light can be emitted for 200 ms and turned off for 800 ms. In addition, orange light can be emitted while the device is emitting an ultrasonic sound. The orange light can flash or otherwise be emitted in between the slow flashing green light. The duration of flashing orange light can be 200 ms on and 200 ms off. The preceding is only an example of how one or more lights or LEDs of the device can be used to provide visual indications. Other options and configurations are possible.

The schematic provided in FIG. 2 is meant only as an example and is not intended to be limiting. A device according to the present disclosure can be built by persons of ordinary skill in the art using different componentry and a different layout.

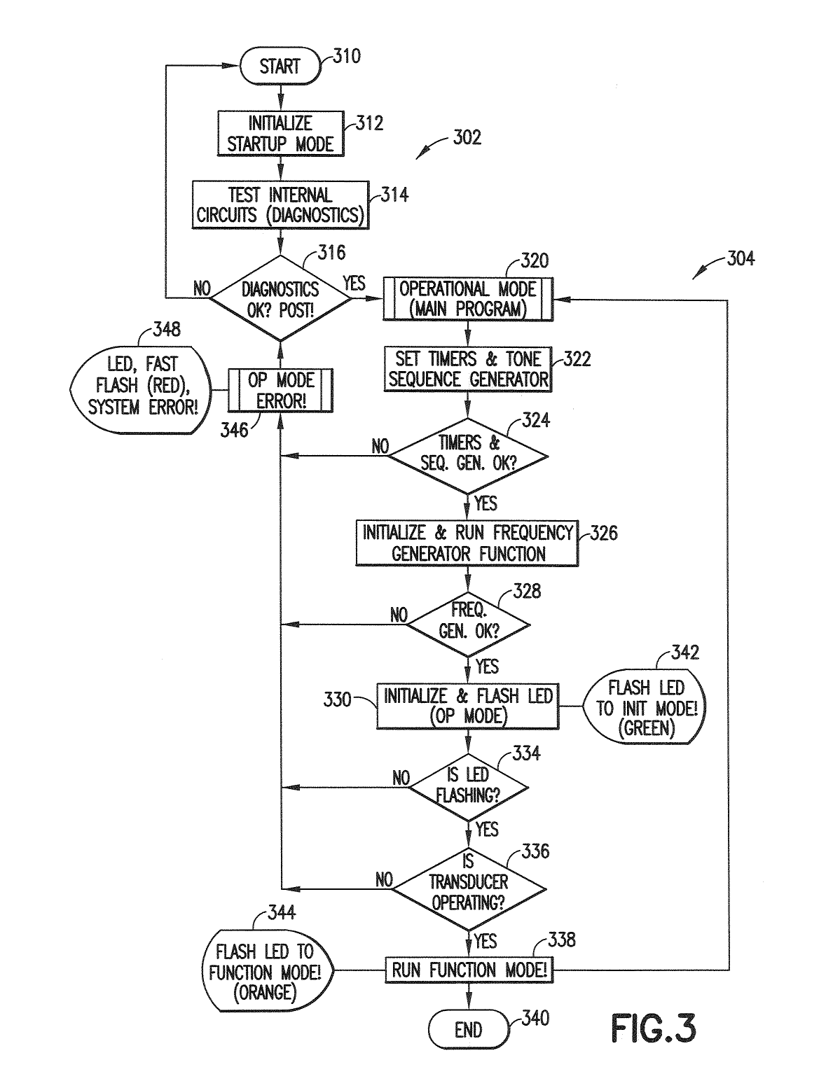

FIG. 3 is an example flow chart indicating various operational modes of at least one embodiment of the present vermin repelling device. The flow chart has two loops, an initialization and internal system test mode loop 302, and a main program run loop 304. Initialization and test loop 302 is described first. The process begins at block 310 and proceeds to block 312 at which a start-up mode of the device is initialized. Here, a power on self-test (POST) can be commenced. The process then proceeds to block 314 where one or more internal circuits of the device are tested. The process then proceeds to block 316 where the results of the diagnostics are checked. If the results of the test or tests are acceptable, the process can move to block 320. If the test results are not acceptable, the process can return to block 310. In addition, if the results are not acceptable, this can be signaled, if possible, by way of a visual indication via the one or more LEDs. For example, the one or more LEDs can emit a red flashing light cycle wherein the light is on for 100 ms and off for 150 ms. However, it is to be appreciated that the initialization failure can be signaled in any other suitable way.

Main program run loop 304 is now described. In the main program, there can be functional diagnostics continuously running to verify the operation of the one or more LEDs, the sound emitter, and other components. The main program mode can contain one or more timers that control one or more of the LED flash rates, the tone sequence generator, the variable frequency generator, and the sound emitter driver. In addition, the main program can contain diagnostic routines that afford a continuous dynamic monitoring of the operation of the device.

A main program of the device is started at block 320. The process then proceeds to block 322 where a tone sequence generator and one or more timers can be initialized. The process proceeds to block 324 where it is determined if the initializations of block 322 have been successful. If the initializations are acceptable, the process moves to block 326 where a frequency generator function is initialized and run. If the initializations of block 322 are not acceptable, the process proceeds to block 346, representing that an operational mode error has occurred. At this stage, the device can provide a visual indication by way of a light or LED. In this embodiment, a particular error or failure can be indicated by way of a flashing red light, as indicated by 348. The process can then proceeds back to block 316.

On the other hand, once a frequency generator function is initialized and run at block 326, the process proceeds to block 328 where it is determined if the frequency generator function is operating properly. If the frequency generator function is not operating properly, the process proceeds to block 346. If the frequency generator function is operating properly, the process proceeds to block 330 where one or more LEDs of the device can be initialized. For example, a flashing green light can be emitted at this point. The process then proceeds to block 334 where it is determined if the LED is flashing. If the LED is not flashing, the process proceeds to block 346. If the LED is flashing, the process proceeds to block 336 where one or more checks are performed on the sound emitter. If the sound emitter is not operating satisfactorily, the process proceeds to block 346. On the other hand, if the sound emitter is functioning properly, the process proceeds to block 338 where a function mode of the device is run. At this stage, one or more LEDs of the device can emit a flashing orange light. The process then proceeds to end block 340.

In at least one embodiment, the device can require no user adjustments and/or user intervention to operate. For example, in one or more embodiments, the device need only be connected to a power source. The device will then power on, initialize, and then enter an operational mode in which ultrasonic sounds will be emitted according to a preprogrammed schedule.

The flow chart shown in FIG. 3 is meant only as an example and is not intended to be limiting.

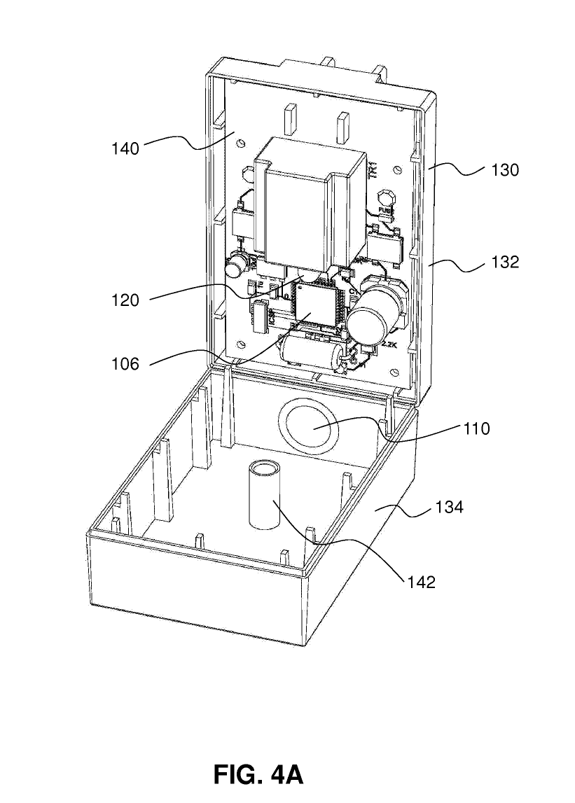

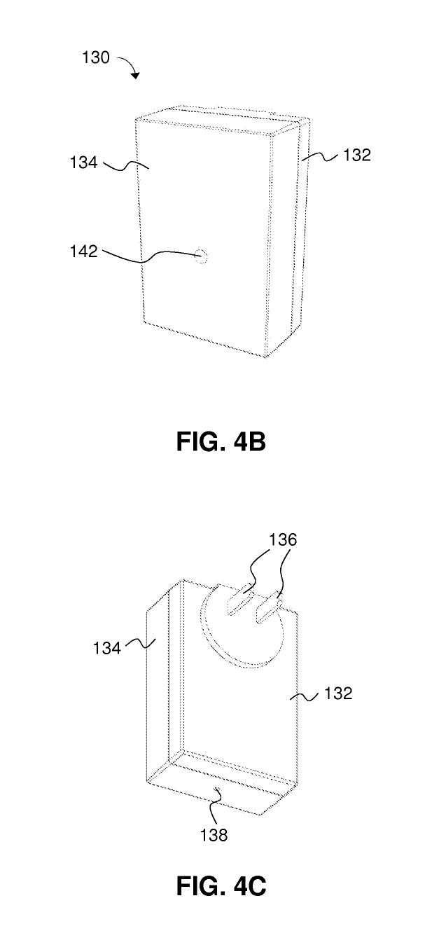

FIGS. 4A to 4C are perspective views of one embodiment of the present device. In this embodiment, device 100 comprises an assembly housing 130, which can be formed of a single piece or can consist of multiple pieces. FIG. 4A shows device 100 with a two-piece assembly housing 130 shown in an open position. Assembly housing 130 can comprise a lower housing 132 and a top housing cover 134. The device can also comprise a printed circuit board 140 onto which various components are mounted. These can include but are not limited to the processor 106, one or more lights or LEDs 120, a power transformer, a power regulator, and an interface driver circuit. The sound emitter 110 can be securely retained in an appropriate location within housing 130. In one or more embodiments, sound emitter 110 can be retained in contact with assembly housing 130, for example so that at least some of the vibrations of the emitter are directly transmitted to the assembly housing. In at least one embodiment, as shown in FIG. 4A, sound emitter is bonded to an internal surface of assembly housing 130. Sound emitter 110 can be bonded to assembly housing 130 by way of silicone or any other suitable bonding material or technique. The use of silicone or a comparable material can help to insulate the sound emitter from any vibrations of the assembly housing. In the at least one embodiment where sound emitter 110 is bonded or otherwise in contact with the assembly housing 130, the assembly housing can act as a baffle for the sound emitter. Assembly housing 130 can be tuned to operate at or near the frequency or frequencies generated by the sound emitter.

Assembly housing 130 may comprise a light tube 142, for example in in or on housing cover 134, for transmitting light emitted by the one or more lights or LEDs 120 from within assembly housing 130 to the exterior of housing 130 so that they can observed by a person. Housing 130 can also comprise one or more electrical couplers 136 for coupling the device to a source of power. As shown in FIG. 4C, couplers 136 can be in the form of prongs to be received into a power socket. In this embodiment, the entire device 100 can be supported about the power socket and would not require any separate mounting hardware.

FIGS. 4B and 4C show top housing cover 134 fully engaged with lower housing 132. In at least one embodiment, top housing cover 134 can be securely fastened to lower housing 132. Furthermore, in one or more embodiments, top housing cover 134 can be permanently fastened, for example by way of welding, ultrasonic welding, bonding, or any other suitable means, to lower housing 132 to prevent easy access to the interior of housing 130. This may be desirable if the device is not intended to be serviceable.

In at least one embodiment, assembly housing 130 can be shaped and sized to act as a resonator in order to provide desirable acoustic properties. In at least one embodiment, housing 130 can be shaped and sized to act as a Helmholtz resonator. A Helmholtz resonator is an acoustic cavity resonator in which sound is produced by air vibrating within a cavity having an opening. The resonator can be tuned to achieve the desired acoustic characteristics. For example, the resonator can be configured to operate at one or more frequencies that correspond to one or more frequencies of the sound generated by the sound emitter. In at least one embodiment, the assembly housing can resonate with the frequency of the emitted sound of the device.

Assembly housing 130 can comprise one or more openings for allowing the sound generated by the sound emitter to exit the housing. As shown in FIG. 4C, housing 130 can define an output port 138 for this purpose. In at least one embodiment, as shown in FIGS. 4A and 4C, sound emitter 110 is located in proximity to output port 138. The one or more openings, such as output port 138, can be shaped and sized based on one or more characteristics of the sound generated by the device. For example, the shape and/or size of the opening or openings can modify or transform sound as it passes through the housing. For instance, the dimensions and shape of an opening could focus the sound in a particular direction, or could alternatively disperse the sound. In addition, in one or more embodiments in which assembly housing 130 is shaped and sized to act as a Helmholtz resonator, the shape and size of the one or more openings can be selected accordingly. In at least one embodiment, output port 138 can have a diameter of approximately ⅛ of an inch in diameter. In addition, in at least one embodiment, output port 138 can have a frusto-conical or near frusto-conical shape, the port widening in an outwardly direction from the interior of assembly housing 130.

In one or more embodiments, assembly housing 130 can be water resistant or water proof in order to protect the internal components from moisture and liquids.

Furthermore, assembly housing 130 can be made of any suitable materials, including but not limited to one or more plastics and thermoplastics.

The use of the vermin repelling device is now described.

In use, the device can be positioned in an area that is to be kept free of vermin or other unwanted animals. In some applications, multiple devices can be used to cover an area greater in size than the operational range of a single device.

In addition, depending on the intended application and the characteristics of the physical space that is to be covered, one or more devices can be positioned above the floor or ground and can direct their sound at least partially downwardly towards the floor. In at least some applications, one or more devices will be positioned at or above approximately 6 inches from the floor or ground.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

Moreover, the previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed is:

1. A method for repelling vermin, the method comprising using a sound emitter to emit an ultrasonic sound to discourage the vermin from at least one of entering and remaining within a vicinity of the sound emitter, the sound having a frequency in the range of approximately 21.5 kHz to 30 kHz.

2. The method of claim 1 wherein the sound is cycled on and off to reduce the chance of vermin becoming accustomed to the sound.

3. The method of claim 2 wherein an on/off cycle comprises an on period of approximately 1 to 5 seconds and an off period of approximately 1 to 5 seconds.

4. The method of claim 3 wherein the on period has a duration of approximately 2 seconds and the off period has a duration of approximately 2 seconds.

5. The method of claim 2 wherein the sound is cycled on and off randomly or pseudo randomly.

6. The method of claim 1 wherein the sound comprises a composite waveform.

7. The method of claim 1 wherein the sound has a variable frequency comprising an upsweep followed by a downsweep.

8. The method of claim 1 wherein the sound has a frequency in a range of approximately 23 kHz to 25 kHz.

9. The method of claim 1 wherein the emitted sound has a sound pressure level above approximately 90 dB.

10. The method of claim 9 wherein the sound has a sound pressure level in the range of approximately 100 dB to 110 dB.

11. A device for repelling vermin, the device comprising:
a sound emitter; and
a circuit operatively connected to the sound emitter to cause the sound emitter to produce an ultrasonic sound to discourage the vermin from at least one of entering and remaining within a vicinity of the device, the ultrasonic sound having a frequency in a range of approximately 21.5 kHz to 30 kHz.

12. The device of claim 11 wherein the sound is cycled on and off to reduce the chance of vermin becoming accustomed to the sound.

13. The device of claim 12 wherein an on/off cycle comprises an on period of approximately 1 to 5 seconds and an off period of approximately 1 to 5 seconds.

14. The device of claim 13 wherein the on period has a duration of approximately 2 seconds and the off period has a duration of approximately 2 seconds.

15. The device of claim 12 wherein the sound is cycled on and off randomly or pseudo randomly.

16. The device of claim 11 wherein the sound comprises a composite waveform.

17. The device of claim 11 wherein the sound has a variable frequency comprising an upsweep followed by a downsweep.

18. The device of claim 11 wherein the sound has a frequency in the range of approximately 23 kHz to 25 kHz.

19. The device of claim 11 wherein the emitted sound has a sound pressure level above approximately 90 dB.

20. The device of claim 19 wherein the sound has a sound pressure level in a range of approximately 100 dB to 110 dB.

21. The device of claim 11 wherein the sound emitter is a piezoelectric transducer.

22. The device of claim 21 wherein the piezoelectric transducer comprises a ceramic portion, a metal portion bonded to the ceramic portion, the metal portion comprising a protuberance extending on a side of the metal portion that is opposite to the ceramic portion, the protuberance for increasing the sound pressure level of the sound produced by the transducer.

23. The device of claim 11 further comprising an assembly housing, wherein the sound emitter and the circuit are disposed within the assembly housing.

24. The device of claim 23 wherein the assembly housing acts as a resonator when the sound emitter is emitting sound.

25. The device of claim 24 wherein the assembly housing defines one output port, and wherein the assembly housing acts as a Helmholtz resonator.

26. The device of claim 23 wherein the sound emitter is retained in contact with the assembly housing.
